(19) United States
(12) Patent Application Publication
(10) Pub. No.: US 2004/0024128 A1
(43) Pub. Date: Feb. 5, 2004

(54) Fluorocarbon powder coating compositions

(76) Inventor: Jack Behrens, Tualatin, OR (US)

Correspondence Address: Charles D. McClung, Chernoff, Vilhauer, McClung & Stenzel, LLP, 1600 ODS Tower, 601 S.W. Second Avenue, Portland, OR, 97204-3157, US

(21) Appl. No.: 10/208,985

(22) Filed: Jul. 30, 2002

(51) Int. Cl. C08L 27/12

(52) U.S. Cl. 525/199

(57) ABSTRACT

A fluorocarbon powder coating including either PVDF or ETFE and VDF/TFE/HFP in which the VDF/TFE/HFP has a weight which is between 6% and 40% of the weight of the PVDF or ETFE.

### BACKGROUND AND SUMMARY OF THE INVENTION

High performance fluorocarbon polymers are established as a powder coating material for metal surfaces where their performance merits their relatively higher cost. These materials have high corrosion resistance which makes them desirable for coating parts that are exposed to a corrosive environment. In addition, they are resistant to ultraviolet and hold up well when exposed to weather, which makes them desirable as an architectural coating. Two important materials in this class are polyvinylidene fluoride (“PVDF”) and ethylene tetrafluoroethylene (“ETFE”). One drawback of these materials is that they do not bond well when applied directly to metal, and in most applications it is necessary to apply a primer coat to the metal first. This extra step increases the cost of coating with these materials.

Simkin, U.S. Pat. No. 5,405,912, teaches that by adding small amounts, 0.1-5% by weight, of a fluorocarbon terpolymer, vinylidene fluoride/tetrafluoroethylene/hexafluoropropropylene (“VDF/TFE/HFP”) to PVDF, there is less surface roughness, or “orange peel,” than if PVDF is used alone. While this solves one problem with PVDF, it does not eliminate the need to use a primer coat when the material is applied to a metal surface.

The subject invention solves the problem of having to first coat a metal surface with primer before applying PVDF or ETFE by mixing these materials with a larger amount of VDF/TFE/HFP than is taught by Simkin.

The foregoing and other objectives, features, and advantages of the invention will be more readily understood upon consideration of the following detailed description of a preferred embodiment of the invention, taken in conjunction with the accompanying drawings.

### DETAILED DESCRIPTION OF THE PREFERRED EMBODIMENT

It has been discovered that by adding a relatively large amount of VDF/TFE/HFP, hereinafter referred to as “the additive material,” to either PVDF or ETFE, hereinafter referred to as the “base material,” the resulting mixture can be applied to a metal part as a powder coating without the necessity of first applying a primer coat. The amount of the additive material by weight is 6-40% of the weight of the base material and preferably is about 15%. The term PVDF includes not only the specific polymer, but also copolymers which are substantially PVDF but contain small amounts of other polymers, such as TFE, HFP, and vinyl fluoride.

In addition to the VDF/TFE/HFP, a small amount of one or more pigments may be added to the mixture to provide color and increase ultraviolet protection. Normally the weight of the pigment would be between 2 and 10% of the weight of the base material, but it could be more or less depending on the particular pigment or pigments. Pigments are commonly added to a fluorocarbon powder coat for this purpose and are well known in the prior art. Finally, a fluidizing material, such as silica, can be added to the mixture to increase the fluidity of the mixture during the mixing and application process. Typically the fluidizing material would have a weight of less than 1% of the weight of the base material. Fluidizing materials used for this purpose are well known in the art.

The polymers are processed and mixed with the pigments and fluidizing material to provide a powder coating in the conventional fashion, using either hot melt blended or dry blending techniques. The metal part that is to be coated is prepared in the conventional manner by doing such things as degreasing and/or sandblasting. Burrs and rough edges are also removed from the metal part. The mixed powder coating is applied to the metal surface in the traditional manner, such as electrostatic spray (both corona and tribo charging techniques), electrostatic fluidizing bed, standard fluidized bed and hot flocking techniques. Finally, the part is heated and the material is fused onto the metal surface in the customary manner. Multiple coats of material can be applied, either with or without cooling between coats, to build the desired thickness of the coating.

Six examples, three for PVDF and 3 for ETFE, showing specific mixtures of the material, are provided below. The PVDF that was used is KK2300 which is manufactured by Kureha Chemical Industry Co., Ltd. of Japan. KK2300 is a PVDF co-polymer. The ETFE that was used is TEFZEL, which is manufactured by du Pont of Wilmington, Del. The VDF/TFE/HFP is either THV500 or THV220, which are manufactured by Dyneon. In the following examples the base material has a specific weight and the remaining components are listed by weight as a percentage of the weight of the base material. Examples 1-4 show base material weighing 2, 5 and 10 lbs. and examples 5 and 6 show base material weighing 2 and 50 lbs.

EXAMPLE 1

| | | | |
|---|---|---|---|
| KF2300, ES, clear | 2 lbs | 5 lbs | 10 lbs |
| Dyneon THV 500 - 15% of the | 136 gms | 12 ozs | 1.5 lbs |
| weight of the KF material | | | |
| Millennium (SCM) Orange Med. | 27 gms | 68 gms | 136 gms |
| 4510 - .3% of the weight of KF | | | |
| material | | | |

EXAMPLE 2

| | | | |
|---|---|---|---|
| KF2300, ES, clear | 2 lbs | 5 lbs | 10 lbs |
| Dyneon THV 500 - 15% of the | 136 gms | 12 ozs | 1.5 lbs |
| weight of the KF material | | | |
| Harcros G-6099 Chromium Oxide - | 27 gms | 68 gms | 136 gms |
| 3% of the weight of the KF material | | | |

EXAMPLE 3

| | | | |
|---|---|---|---|
| KF2300, ES, Clear | 2 lbs | 5 lbs | 10 lbs |
| Dyneon THV 500 - 15% of the | 136 gms | 12 ozs | 1.5 lbs |
| weight of the KF material | | | |
| Shepherd Black 430 - 3% of the | 27 gms | 68 gms | 136 gms |
| weight of the KF material | | | |
| Cabot CT-1111G Silica - | 0.45 gms | 1.13 gms | 2.62 gms |
| 0.05% of the weight of the KF | | | |
| material | | | |

EXAMPLE 4

| | | | |
|---|---|---|---|
| Tefzel HT 2195, ES | 2 lbs | 5 lbs | 50 lbs |
| Tefzel HT 2182 Fluf, ES - 15% | 136 gms | 340 gms | 7.5 lbs |
| of the weight of the Tefzel 2195 | | | |
| Dyneon THV 500P - 10% of the | 91 gms | 227 gms | 5 lbs |
| weight of the Tefzel 2195 | | | |
| Shepherd Blue 299 - 3% of the | 27.2 gms | 68 gms | 1.5 lbs |
| weight of the Tefzel 2195 | | | |
| Cabot Cab-O-Sil CT-1111G-0.05% | 0.45 gms | 1.1 gms | 11.3 gms |
| of the weight of the Tefzel | | | |
| 2195 | | | |

EXAMPLE 5

| | | |
|---|---|---|
| Tefzel HT 2195 Ground 1X | 2 lbs | 50 lbs. |
| Dyneon THV-500P - 10% of the | 91 gms | 5 lbs |
| weight of the Tefzel | | |
| Shepherd Blue 299 - 3% of the | 27.2 gms | 1.5 lbs |
| weight of the Tefzel | | |
| Cabot Cab-O-Sil CT-1111G - 0.02% | 0.2 gms | 5 gms |
| of the weight of the Tefzel | | |

EXAMPLE 6

| | | |
|---|---|---|
| Tefzel HT 2195 Ground 1X | 5 lbs | 50 lbs |
| Dyneon THV 220A - 10% of the | 227 gms | 5 lbs |
| weight of the Tefzel | | |
| Millennium Cad Pure Orange Deep | 52.2 gms | 521.6 |
| 4520 - 2.3% of the weight of | | gms |
| the Tefzel | | |
| Tronox CR-828 Ti02 - 0.05% of | 11.3 gms | 113.4 gms |
| the weight of the Tefzel | | gms |
| Cabot Cab-O-Sil CT-1111G - 0.02% | 0.45 gms | 4.5 gms |
| of the weight of the Tefzel | | |

In addition to allowing the PVDF and the ETFE to be applied as a powder coat directly to metals without having to apply a primer coat, the addition of the VDF/TFE/HFP improves the impact resistance, flexibility and elongation characteristics, and permeation resistance to water, hydrocarbon fuels and other chemicals.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. A powder coating comprising a base amount of a PVDF resin, a pigment and about 6-40% of the base amount by weight of a VDF/TFE/HFP terpolymer.

2. A powder coating of claim 1 wherein there is about 15% by weight of a VDF/TFE/HFP terpolymer.

3. A powder coating comprising a base amount of an ETFE resin, a pigment and about 6-40% of the base amount by weight of a VDF/TFE/HFP terpolymer.

4. The powder coating of claim 2 wherein there is about 15% of the base amount by weight of a VDF/TFE/HFP terpolymer.
